(19) United States
(12) Patent Application Publication
(10) Pub. No.: US 2015/0032255 A1
(43) Pub. Date: Jan. 29, 2015

(54) ARRANGEMENT OF AN ACTUATOR AND AN ACTUATOR HOLDER

(71) Applicant: Rolf Strothmann, Saarbrucken (DE)

(72) Inventor: Rolf Strothmann, Saarbrucken (DE)

(21) Appl. No.: 14/382,685

(22) PCT Filed: Mar. 5, 2013
(86) PCT No.: PCT/DE2013/100082

§ 371 Date: Sep. 3, 2014

(30) Foreign Application Priority Data
Mar. 6, 2012 (DE) 10 2012 101 873.1
Apr. 5, 2012 (DE) 10 2012 102 971.7

(51) Int. Cl. B25J 9/00; B25J 18/00

(52) U.S. Cl. CPC B25J 9/00; B25J 18/00; Y10S 901/23
USPC 700/245; 74/490.02; 901/23

(57) ABSTRACT

An arrangement of an actuator and an actuator holder. The actuator is movably connected to the actuator holder, and devices are provided for supplying the actuator with operating energy. The devices for supplying the actuator with operating energy include an energy store integrated into the actuator. The actuator is preferably movable relative to the actuator holder in at least one dimension in an unrestricted manner.

The invention pertains to an arrangement consisting of an actuator and an actuator holder, wherein the actuator is movably connected to the actuator holder, and devices are provided for supplying the actuator with operating energy.

An actuator of this type, movably connected to a holder and to be supplied with operating energy, can be, for example, the arm of a robot, which is pivotably connected to another robot arm forming the actuator holder. In another actual example, the actuator is formed by an assembly consisting of a wheel and a rotary drive device for the wheel, wherein the assembly is pivotable around an axis perpendicular to the rotational axis of the wheel and is connected to a holder in the form of a frame.

The present invention creates a new arrangement of the type described above, which is characterized in that the devices for supplying the actuator with operating energy comprise an energy storage unit integrated into the actuator,

That the integrated energy storage unit can supply strong electric current to operate the actuator is advantageous, because a movable connection between the actuator and the actuator holder makes it difficult to transmit strong current over electrical lines extending between the actuator holder and the actuator.

The advantage mentioned above is especially evident in an embodiment in which the actuator is movable without restriction relative to the actuator holder in at least one dimension, and in which the actuator is pivotable, for example, relative to the actuator holder around any desired rotational angle. In the latter case, the transmission of energy over electrical lines connecting the two components would require complicated sliding contacts. The actuator, pivotable around any desired angle, could comprise, in addition to the energy storage unit, only the rotor of an electrical machine, for example, the rotor being provided with pole windings, and the actuator holder could be formed by the stator of that machine.

In an arrangement according to the invention, it is advisable to provide devices for the contactless transmission of operating energy to the energy storage unit, especially for the transmission of operating energy from the actuator holder to the actuator. The transmission power which can be transmitted need only correspond to the time-averaged operating energy required by the actuator.

In one embodiment of the invention, a drive device is provided to move the actuator relative to the actuator holder.

This drive device, possibly provided in addition to other drive devices of the actuator, can, like the other drive devices, receive its operating energy from the energy storage unit.

The above-mentioned drive device preferably comprises a component connected only to the actuator and a component connected only to the actuator holder; that is, the drive device is formed both by the actuator and by the actuator holder.

The component connected only to the actuator can be a rotor, and the component connected only to the actuator holder can be a stator of a drive motor forming the drive device, by means of which the actuator is, for example, pivotable around any desired rotational angle.

In a preferred embodiment of the invention, the rotor comprises pole windings, and the stator comprises devices for generating the excitation field of the drive motor. The integrated energy storage unit, rotating along with the rotor, supplies the current flowing through the pole windings.

The devices for transmitting operating energy can be formed by parts of the previously mentioned drive device, namely, the drive device which moves the actuator, wherein the stator of the drive motor is possibly provided with a winding capable of transmitting operating energy to the energy storage unit.

This winding can also be used to generate the magnetic field of the drive motor. Alternatively, the winding can also be provided in addition to the permanent magnets of the stator, wherein the fields of the permanent magnets and of the winding can be superimposed, so that in particular a varying d value is obtained. Even when the d value has a large amplitude, it is still possible to arrive at the desired q value. Because the d value can also be influenced on the actuator side, it is possible in principle to transmit energy and/or data in both directions.

In one embodiment, the actuator comprises a wheel and a rotary drive device for the wheel. The axis of the wheel is preferably perpendicular to the axis around which the actuator is pivotable relative to the actuator holder, e.g., a frame holding the wheel assembly,

It is obvious that the transmission of energy can also proceed in the opposite direction, i.e., from the actuator to the actuator holder, e.g., when the drive motor of the wheel is operating in generator mode.

The arrangement according to the invention can be cascaded, wherein the actuator holder itself forms in turn part of an additional actuator.

The invention is explained in greater detail below on the basis of an exemplary embodiment and the attached drawings, which pertain to this exemplary embodiment:

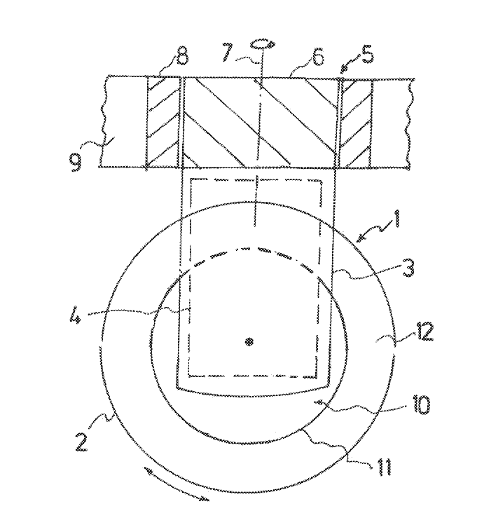

FIG. 1 shows an arrangement according to the invention with an actuator unit comprising a driven wheel, the actuator unit being connected to a frame rotatably around an axis perpendicular to the axis of the wheel; and

FIG. 2 shows a schematic circuit diagram to explain the function of the arrangement of FIG. 1.

An arrangement shown in FIG. 1 comprises an actuator unit 1, which, in the exemplary embodiment shown here, comprises a wheel 2, a wheel holder 3, and a storage battery 4. The storage battery 4 indicated in the broken line is accommodated in the wheel holder 3. The actuator unit 1 also comprises, as an additional component, a rotor 6, adjacent to the wheel holder 3; this rotor, as part of a drive motor 5, is rotatable around a pivot axis 7 relative to a stator 8. The pivot axis 7 is perpendicular to the rotational axis of the wheel 2.

The stator 8 of the drive motor 5, which forms a pivot drive for the actuator unit 1, is rigidly connected to a holder 9, only part of which is shown; in the exemplary embodiment shown here, this holder is a frame of a mobile device (the rest of which is not shown).

In the example in question, the rotor 6 comprises pole windings, through which battery current flows, whereas the stator 8 generates the excitation field of the drive motor 5 by means of permanent magnets, for example Neither the pole windings nor the permanent magnets are shown in FIG. 1.

The actuator unit 1 also comprises a drive motor 10, which rotates the wheel 2 around the wheel axis and is accommodated in the wheel, with a stator 11 and an external rotor 12, which rotates the wheel.

So that it can be operated, the drive motor 10, as shown in FIG. 2, can be connected to the storage battery 4 by a circuit 13, wherein the operation of the motor is controllable by the circuit 13. The drive motor 5 controllable by the circuit 14 also obtains operating energy from the storage battery 4 for the pivoting drive of the actuator unit 1.

A winding 15 (not shown in FIG. 1) is provided on the stator 8 and forms, together with the other parts of the stator 8, a structural unit 16, which is indicated in broken line in FIG. 2 and which is connected to the holder 9. The winding 15 can be provided on the stator 8 instead of or in addition to permanent magnets, wherein, in the former case, it can be used to generate the excitation field of the drive motor 5

The actuator unit 1 is pivotable by the drive motor 5 around any desired rotational angle. If the actuator unit 1 were not provided with the storage battery 4, operating energy would have to be supplied to the rotary drive motor 10 and the pivoting drive motor 5 in a disadvantageous manner, e.g., by way of sliding contacts.

The storage battery 4 can in particular meet short-term peak power requirements of the rotary drive motor 10. The time-averaged drive energy which is required can be transmitted in contactless fashion by means of the winding 15, which, together with the pole windings of the rotor 6 of the pivoting drive motor 5, forms a transmission device. The battery 4 can store transmitted energy on an interim basis.

It is obvious that energy generated by the rotary drive. motor 10 when in generator mode can be transmitted in contactless fashion by the reverse route via the pivoting drive motor 5 and the winding 15 integrated into it,

The transformational coupling between the actuator 1 and the actuator holder 9 by way of the winding 15 allows not only the transmission of energy but also the transmission of data As a result of this coupling, modulations of flowing currents are always detected on the other side.

Such data transmission from the actuator holder 1 to the actuator holder 9 could be carried out in particular by pulse width modulation (PWM) as part of the operation of the pivoting drive motor 5.

Binary code can be incorporated. into the PWM cycles. For example, a shift in the switchover points in successive PWM cycles could be used for binary coding, wherein, for example, no shift between two successive cycles codes for the value “0”, whereas a positive shift in one cycle and a negative shift in the following cycle represents the value “1”.

In view of the relatively high frequency of PWM cycles, a correspondingly large amount of data can be transmitted,

1-15. (canceled)

16. An arrangement comprising: an actuator; an actuator holder, wherein the actuator is movably connected to the actuator holder; and devices for supplying the actuator with operating energy, wherein the devices for supplying the actuator with operating energy comprise an energy storage unit integrated into the actuator.

17. The arrangement according to claim 16, wherein the actuator is movable without restriction in at least one dimension relative to the actuator holder,

18. The arrangement according to claim 17, wherein the actuator is pivotable around any desired rotational angle relative to the actuator holder.

19. The arrangement according to claim 16, further comprising devices for contactless transmission of operating energy to the energy storage unit.

20. The arrangement according to claim 19, wherein the devices for contactless transmission of operating energy transmit the operating energy from the actuator holder to the actuator.

21. The arrangement according to claim 19, wherein transmission power of the transmission devices corresponds at least to a time-averaged operating energy required by the actuator.

22. The arrangement according to claim 19, further comprising a drive device for moving the actuator relative to the actuator holder.

23. The arrangement according to claim 22, wherein the drive device obtains operating energy from the energy storage unit.

24. The arrangement according to claim 22, wherein the drive device includes a first component connected only to the actuator and a second component connected only to the actuator holder.

25. The arrangement according to claim 24, wherein the first component connected only to the actuator is a rotor, and the second component connected only to the actuator holder is a stator of a drive motor forming the drive device.

26. The arrangement according to claim 25, wherein the rotor comprises pole windings, and the stator comprises devices for generating an excitation field of the drive motor.

27. The arrangement according to claim 22, wherein the devices for contactless transmission of operating energy are formed by parts of the drive device for movement of the actuator.

28. The arrangement according to claim 25, wherein the stator is provided with a winding that transmits operating energy to the energy storage unit.

29. The arrangement according to claim 28, wherein the winding also generates an excitation field of the drive motor.

30. The arrangement according to claim 28, wherein the stator includes permanent magnets, and the winding is provided in addition to the permanent ^{magnets} of the stator.

31. The arrangement according to claim 16, wherein the actuator includes a wheel and a rotary drive device for the wheel, wherein the wheel has a rotational axis perpendicular to an axis around which the actuator is pivotable relative to the actuator holder.

32. The arrangement according to claim 22, wherein the devices for contactless transmission of operating energy are configured to also transmit data.

33. The arrangement according to claim 32, wherein the devices for contactless transmission of energy are configured to transmit data by pulse width modulation in successive pulse cycles during operation of the drive device for moving the actuator relative to the actuator holder.
